(19) United States
(12) Patent Application Publication
(10) Pub. No.: US 2022/0403173 A1
(43) Pub. Date: Dec. 22, 2022

(54) LIGNOCELLULOSIC FOAM COMPOSITIONS AND METHODS OF MAKING THEREOF

(71) Applicant: University of Maine System Board of Trustees, Orono, ME (US)

(72) Inventors: Michael Darin Mason, Orrington, ME (US); Mehdi Tajvidi, Orono, ME (US); Aileen Co, Orono, ME (US); Seyed Ali Haji Mirza Tayeb, Old Town, ME (US); Islam Hafez, Orono, ME (US); David Gregg Holomakoff, Portland, ME (US)

(21) Appl. No.: 17/772,863

(22) PCT Filed: Oct. 28, 2020
(86) PCT No.: PCT/US2020/057711

§ 371 Date: Apr. 28, 2022

Related U.S. Application Data
(60) Provisional application No. 62/927,392, filed on Oct. 29, 2019.

(51) Int. Cl. C08L 97/02; C08J 9/28; F26B 3/347

(52) U.S. Cl. CPC C08L 97/02; C08J 9/28; F26B 3/347; C08L 2205/16; C08J 2397/02; C08J 2201/05; C08J 2205/04; F26B 2200/02

(57) ABSTRACT

The present invention includes methods of making a nanocellulosic composition comprising one or more nanocellulosic components, wherein the one or more nanocellulosic components comprise a micron-scale cellulose or cellulose nanofibrils (CNF), the method comprising the steps of: creating a nanocellulosic slurry by combining the one or more of nanocellulosic components with a liquid component; and exposing the nanocellulosic slurry to a drying condition, wherein the drying condition comprises microwave radiation, thereby creating a nanocellulosic composition. The present invention also includes compositions comprising cellulose (nanocellulosic compositions), wherein the nanocellulosic compositions have an internal void space of about 5% to about 95% by volume.

### CROSS-REFERENCE TO RELATED APPLICATION

The present application claims the benefit of U.S. Provisional Patent Application No. 62/927,392, filed Oct. 29, 2019, the content of which is hereby incorporated by reference in its entirety.

### BACKGROUND

Low density, porous and/or permeable materials, such as foams, that are composed of low-cost renewable materials and comprise controlled variables such as density, porosity, and pore size distribution, are of great interest for a number of applications ranging from packaging to biomedical materials. Microwave radiation has been used previously to successfully expand and dewater starch slurries producing low modulus foam materials. However, creating foams out of starch requires large quantities of starch, typically about 50% by weight. Additionally, there is a narrow range of starch by weight that can be successfully used to make foams. If too much starch is used, the starch does not disperse. If too little starch is used, only a very weak structure is formed. It would be advantageous if there were a new class of low-cost, low-density materials that could be generated from renewable and compostable feedstocks, particularly if they had well-defined and controlled mechanical properties such as flexural and compressive modulus, and could be manipulated further for packaging and consumer applications.

### SUMMARY OF THE INVENTION

The present invention relates generally to the field of lignocellulosic products (e.g., wood pulp, wood fiber, wood nanofiber, non-wood plant materials, such as cotton fiber) and wood residues (e.g., sawdust, wood flour, planer shavings, etc.), and using microwave radiation to partially or fully dry a slurry to produce low density materials that exhibit mechanical properties significantly greater than materials of a similar composition and density produced without the use of microwave radiation.

The present disclosure provides a new cost-effective process for producing high-quality foams composed of CNF or CNF-composites comprising CNF and low-cost and naturally sourced wood residues (e.g., wood flour, pulp, fiber, chips, etc.), wherein the foams have well-defined and controlled properties such as density, porosity, pore size distribution, biocompatibility, hydrophobicity, dissolution kinetics. These foams can also be manipulated for biomedical applications.

In one aspect, the present disclosure provides methods of making a lignocellulosic composition comprising one or more lignocellulosic components, wherein the one or more lignocellulosic components comprise a micron-scale cellulose and/or cellulose nanofibrils (CNF), the methods comprising the steps of: (a) creating a lignocellulosic slurry by combining the one or more of lignocellulosic components with a liquid component; and (b) exposing the lignocellulosic slurry to a first drying condition, wherein the first drying condition comprises microwave radiation, thereby creating a first lignocellulosic composition.

In some embodiments, a first drying condition comprises one or more drying sessions. In some embodiments, one or more drying sessions are separated in time by intervals ranging from minutes to days. In some embodiments, one or more drying sessions comprise identical microwave conditions. In some embodiments, one or more drying sessions comprise microwave conditions that vary in one or more microwave parameters from at least one other drying session. In some embodiments, one or more microwave parameters comprise microwave power, microwave wavelength, microwave frequency, microwave directionality, microwave flux and duration of microwave exposure. In some embodiments, one or more drying sessions comprises one drying session and, during the one drying session, the microwave radiation varies in one or more of power, wavelength, frequency, directionality and flux.

In some embodiments, variation in microwave radiation results in a first lignocellulosic composition having variable porosity. In some embodiments, variation in microwave radiation results in a first lignocellulosic composition having homogenous porosity. In some embodiments, microwave radiation has a power of about 5 W/kg of lignocellulosic slurry to about 100 kW/kg of lignocellulosic slurry. In some embodiments, a lignocellulosic slurry is exposed to the microwave radiation for a duration comprising about 10 seconds to 90 hours per kg of lignocellulosic slurry. In some embodiments, a lignocellulosic slurry is contained in a mold when exposed to microwave radiation for at least one microwave radiation session. In some embodiments, a lignocellulosic slurry is not contained in a mold when exposed to microwave radiation for at least one microwave radiation session. In some embodiments, a lignocellulosic slurry is extruded when exposed to the microwave radiation for at least one microwave radiation session.

In some embodiments, a lignocellulosic slurry comprises about 0.1% to about 20% nanocellulose fiber solids by total weight. In some embodiments, a lignocellulosic slurry comprises about 1% to about 10% CNF. In some embodiments, a lignocellulosic slurry comprises about 10% to 100% CNF. In some embodiments, a lignocellulosic slurry further comprises one or more additives. In some embodiments, one or more additives comprise about 1% to about 50% of a lignocellulosic slurry by total weight. In some embodiments, one or more additives comprise wood derivatives, metal particles, latex particles, bioceramics, glass materials, proteins, fluorescent dyes, minerals, natural fibers, polymer materials, or any combination thereof. In some embodiments, one or more additives comprise wood residues.

In some embodiments, a lignocellulosic slurry is exposed to microwave radiation until the liquid component content is about 0.01% to about 20% by weight.

In some embodiments, methods of the present disclosure further comprise a step of: (c) exposing a first lignocellulosic composition to a second drying condition, thereby creating a second lignocellulosic composition. In some embodiments, a second drying condition comprises thermal energy, vacuum, lyophilization or air drying. In some embodiments, a second drying condition induces a different rate of liquid component removal than the first drying condition.

In some embodiments, a second lignocellulosic composition comprises different material properties compared to a first lignocellulosic composition. In some embodiments, a second lignocellulosic composition comprises a lower liquid component content by weight compared to the first lignocellulosic composition.

In some embodiments, methods of the present disclosure further comprise the step of: (d) covering a first lignocellulosic composition of (b) or covering a second lignocellulosic composition of (c) with a layer of a shell material, thereby creating a dried lignocellulosic composition with an outer layer of shell material. In some embodiments, methods of the present disclosure further comprise the step of: (e) exposing a dried lignocellulosic composition with an outer layer of shell material to a third drying condition, thereby creating a dried lignocellulosic composition with an outer layer of dried shell material.

In some embodiments, the outer layer of dried shell material is more dense than the first lignocellulosic composition of (b) and/or the second lignocellulosic composition of (c). In some embodiments, the outer layer of dried shell material is less dense than the first lignocellulosic composition of (b) and/or the second lignocellulosic composition of (c). In some embodiments, shell material comprises CNF, wood derivatives, metal particles, latex particles, bioceramics, glass materials, proteins, fluorescent dyes, minerals, natural fibers, polymer materials, or any combination thereof.

In some embodiments, a third drying condition comprises microwave radiation, thermal energy, vacuum, lyophilization or air drying.

In another aspect, the present disclosure provides compositions comprising one or more lignocellulosic components (lignocellulosic compositions), wherein the lignocellulosic compositions have an internal void space of about 5% to about 95% by volume.

In some embodiments, a lignocellulosic composition has a density of about 0.03 g/cm³ to about 5 g/cm³.

In some embodiments, one or more lignocellulosic components comprise a micron-scale cellulose and/or cellulose nanofibrils (CNF).

In some embodiments, a lignocellulosic composition has a nanocellulose fiber solids content of about 1% by weight to about 95% by weight.

In some embodiments, internal void space is distributed homogenously throughout the composition. In some embodiments, internal void space is distributed variably across at least two regions of the composition. In some embodiments, the at least two regions comprise a first region having a first internal void space by volume and a second region having a second internal void space by volume. In some embodiments, there is a gradual change in internal void space by volume from a first region to a second region. In some embodiments, there is a step-wise change in internal void space by volume from a first region to a second region. In some embodiments, a first region is interior relative to the second region in the lignocellulosic composition. In some embodiments, a second region is interior relative to a first region in a lignocellulosic composition. In some embodiments, a first region is layered horizontally relative to a second region in the lignocellulosic composition. In some embodiments, a first internal void space by volume is less than a second internal void space by volume.

In some embodiments, a lignocellulosic composition further comprises one or more additives. In some embodiments, one or more additives modify physical, mechanical or chemical properties of a lignocellulosic composition relative to an identical lignocellulosic composition lacking the one or more additives. In some embodiments, one or more additives comprise wood derivatives, metal particles, latex particles, bioceramics, glass materials, proteins, fluorescent dyes, minerals, natural fibers, polymer materials, or any combination thereof.

In some embodiments, a lignocellulosic composition has a flexural modulus between about 100 kPa and about 2500 MPa. In some embodiments, a lignocellulosic composition has a compression strength between about 10 kPa and about 100 MPa

### BRIEF DESCRIPTION OF THE DRAWING

The drawings are for illustration purposes only, not for limitation.

FIG. 1 shows a graph illustrating the relationship between density and R-value of a composition comprising wood fiber and cellulose nanofibrils (CNF) and formed using microwave radiation.

FIG. 2 shows a graph illustrating the relationship between density and compressive strength of a composition comprising wood fiber and cellulose nanofibrils (CNF) and formed using microwave radiation.

FIG. 3 shows trimmed and sanded panels of a lignocellulosic composition with a density of 0.20 g/cm³.

FIGS. 4A, 4B, and 4C show scanning electron microscopy images of the differences in pore structures for low, medium, and high-density panels.

FIG. 5 shows a graph of the mass of CNF slurries over time when dried with different energy outputs.

FIG. 6 shows a graph of the percent weight of nanocellulose fibers over time when dried with different energy outputs.

FIG. 7 shows a graph of the water mass lost from slurries over time when dried with different energy outputs.

FIG. 8 shows a photograph of nanocellulose foam that resulted from using microwave radiation for pore formation and initial drying.

FIG. 9 shows photographs of a pure very low-density (<0.05 g/cm³) CNF foam material.

FIG. 10 shows photographs of exemplary low-density CNF/wood residue foam compositions.

FIG. 11 shows a bar graph comparing the flexural strength of foam materials manufactured using traditional hot-press methods, compared to those prepared using the microwave-assisted method.

### DEFINITIONS

In order for the present invention to be more readily understood, certain terms are first defined below. Additional definitions for the following terms and other terms are set forth throughout the specification. The publications and other reference materials referenced herein to describe the background of the invention and to provide additional detail regarding its practice are hereby incorporated by reference.

Approximately or about: As used herein, the term “approximately” or “about,” as applied to one or more values of interest, refers to a value that is similar to a stated reference value. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Cellulose Nanofibrils: As used herein, the term “cellulose nanofibrils” refers to the state of cellulosic material wherein at least 75% of the cellulosic material would be considered to be “fines”. In some embodiments, the proportion of cellulosic material that may be considered fines may be much higher such as 80%, 85%, 90%, 95%, 99% or higher. In this disclosure, the terms “nanofibrils”, “nanocellulose”, “highly fibrillated cellulose”, and “super-fibrillated cellulose” are all considered synonymous with cellulose nanofibrils.

Fines: As used herein, the term “fines” refers to cellulosic material, or a portion of a cellulosic fiber with a weighted fiber length of less than 0.2 mm. In some embodiments, “fines” may refer to a cellulosic material that has a diameter of between 5 nm-100 nm, inclusive, and has a high surface to volume ratio and a high length/diameter (aspect) ratio.

Improve, increase, or reduce: As used herein, the terms “improve,” “increase” or “reduce,” or grammatical equivalents, indicate values that are relative to a baseline measurement, such as a measurement in the same sample prior to initiation of a treatment or process step described herein, or a measurement in a control sample (or multiple control samples) in the absence of a treatment or process step described herein.

Lignocellulosic residues: As used herein, “lignocellulosic residues” refers to wood or lignocellulosic materials including any type of small particles in the range of a few microns to a few centimeters that are derived from wood or other lignocellulosic sources. In some embodiments, a lignocellulosic residue may be provided generally as result of sawing, planing, surfacing and finishing.

Microwave radiation: As used herein, the term “microwave radiation” refers to a form of electromagnetic radiation with a wavelength between one millimeter and one meter, inclusive, and a frequency between 300 megahertz (MHz) and 300 gigahertz (GHz), inclusive. In some embodiments, microwave radiation may have a frequency between 500 MHz and 100 GHz, between 500 MHz and 50 GHz, between 500 MHz and 10 GHz, or between 500 MHz and 5 GHz. In some embodiments, microwave radiation may have a frequency of 915 MHz. In some embodiments, microwave radiation may have a frequency of 2,450 MHz. In some embodiments, microwave radiation may have a frequency between 915 MHz and 2,450 MHz, inclusive.

Substantially: As used herein, the term “substantially” refers to the qualitative condition of exhibiting total or near-total extent or degree of a characteristic or property of interest. One of ordinary skill in the chemical arts will understand that biological and chemical phenomena rarely, if ever, go to completion and/or proceed to completeness or achieve or avoid an absolute result. The term “substantially” is therefore used herein to capture the potential lack of completeness inherent in many biological and chemical phenomena.

### DETAILED DESCRIPTION

The present invention relates generally to the field of wood products (e.g., pulp, fiber, and nanofiber) and lignocellulosic residues (e.g., sawdust, wood flour, planer shavings, etc.), and using microwave radiation to partially or fully dry a slurry to produce, for example, low density materials that exhibit improved mechanical properties as compared to materials of a similar composition and density produced without the use of microwave radiation.

Although previous work demonstrates that microwave radiation can be used to effectively foam and dewater starch slurries that work does not extend to foaming lignocellulosic slurries with microwave radiation. Starch is a non-fibrous polysaccharide, and previous work has used these large macromolecular polymers as the basic building blocks and structural elements for foams. Unlike starch, cellulose nanofibrils (also referred to herein as CNF and/or micro-fibrillated cellulose (MFC)) are fibrous particles comprising cellulose-based polymers (i.e., not a polymer molecule)).

Nanofibrillated celluloses have previously been shown to be useful as reinforcing materials in wood and polymeric composites, as barrier coatings for paper, paperboard and other substrates, and as a papermaking additive to control porosity and bond dependent properties. A number of groups are looking at the incorporation of nanocellulose materials into paper or other products; while other research groups are looking at using this material at low concentrations for reinforcements of certain plastic composites. In these cases, the prevalent thinking is that nanofibers can be used in combination with a polymeric binder in composites, typically as reinforcement, not as a replacement adhesive in lieu of the polymers. For example, Veigel S., J. Rathke, M. Weigl, W. Gindl-Altmutter, in “Particleboard and oriented strand board prepared with nanocellulose-reinforced adhesive”, J. of Nanomaterials, 2012, Article ID 158503 1-8, (2012) discuss using nanocellulose to reinforce the polymeric resins, but still retain resins in the system. The approaches by these other groups use only small volumes of fibers in high-value products to enhance a specific property, but not as the sole or principal component. Additionally, US2015/0033983 (incorporated herein by reference it its entirety) describes certain building materials that can be made using cellulose nanofibers as a binder for wood or other cellulose composites.

The present disclosure provides new processes for producing high-quality foams including one or more of CNF and/or CNF-composites comprising CNF and low-cost and naturally sourced wood residues (e.g., wood flour, pulp, fiber, chips, etc.), wherein the foams have well-defined and controlled properties such as density, porosity, pore size distribution, biocompatibility, hydrophobicity, and dissolution kinetics. These foams can also be manipulated for biomedical applications.

### Lignocellulosic Materials

According to various embodiments, any of a variety of lignocellulosic materials may be used in provided methods. In some embodiments, the lignocellulosic material is selected from the group consisting of wood, wood waste, spent pulping/fractionation liquors, algal biomass, food waste, grasses, straw, corn stover, corn fiber, agricultural products and residuals, forest residuals, saw dust, wood shavings, sludges and municipal solid waste, bacterial cellulose and mixtures thereof. In some embodiments, the lignocellulosic material is or comprises pulp fibers, microcrystalline cellulose, and cellulosic fibril aggregates. In some embodiments, a lignocellulosic material is or comprises a micron-scale cellulose. In some embodiments, a lignocellulosic material is or comprises nanocellulose. In some embodiments, a nanocellulose is or comprises cellulose nanofibrils. In some embodiments, cellulose nanofibrils are or comprise microfibrillated cellulose, nanocrystalline cellulose, and bacterial nanocellulose.

Cellulose Nanofibrils (CNF)

Nanofibrils of cellulose are also known in the literature as microfibrillated cellulose (MFC), cellulose microfibrils (CMF), nanofibrillated cellulose (NFC) and cellulose nanofibrils (CNF), but these are different from nanocrystalline cellulose (NCC) or cellulose nanocrystals (CNC). Despite this nomenclature variability in the literature, various embodiments are applicable to nanocellulose fibers independent of the actual physical dimensions, provided at least one dimension (typically a fiber width) is in the nanometer range. CNF are generally produced from wood pulps by a refining, grinding, or homogenization process, described below, that governs the final length and length distribution. The fibers tend to have at least one dimension (e.g. diameter) in the nanometer range, although fiber lengths may vary from 0.1 μm to as much as about 4.0 mm depending on the type of wood or plant used as a source and the degree of refining. In some embodiments, the “as refined” fiber length is from about 0.2 mm to about 0.5 mm. Fiber length is measured using industry standard testers, such as the TechPap Morphi Fiber Length Analyzer. Within limits, as the fiber is more refined, the % fines increases and the fiber length decreases.

In some embodiments, CNF are obtained from wood-based residues. In some embodiments, wood-based residues comprise sawdust. In some embodiments, wood-based residues comprise wood flour. In some embodiments, wood-based residues comprise wood shavings. In some embodiments, wood-based residues comprise woodchips. These types of CNF material are normally known as lignin-containing cellulose nanofibrils (LCNF).

### Lignocellulosic Slurry

In accordance with various embodiments, lignocellulosic slurries of the present invention comprise one or more cellulosic materials suspended in a liquid component, such as water. In some embodiments, a slurry comprises a suspension, colloid, mixture, emulsion, or hydrogel. In some embodiments, a cellulosic component of a lignocellulosic slurry comprises a micron-scale cellulose. In some embodiments, a cellulosic component of a lignocellulosic slurry comprises CNF. In some embodiments, a cellulosic component of a lignocellulosic slurry comprises wood-based residues.

In some embodiments, a lignocellulosic slurry comprises a liquid component wherein the liquid component is water. In some embodiments, a lignocellulosic slurry comprises a liquid component wherein the liquid component is an alcohol. In some embodiments, an alcohol is ethanol. In some embodiments, a liquid component comprises a mixture of water and an alcohol. In some embodiments, a liquid component is acetone.

In some embodiments, a lignocellulosic slurry comprises about 0.1% to about 20% (e.g., 0.1 to 15%, 0.1 to 10%, 0.1 to 5%, 0.5 to 20%, 0.5 to 15%, 0.5 to 10%, 0.5 to 5%, 1 to 20%, 1 to 15%, 1 to 10%, 1 to 5%) nanocellulose fiber solids by total weight, wherein the total weight comprises all solid components and liquid components present in the slurry.

In some embodiments, a lignocellulosic slurry comprises one or more additives. In some embodiments, an additive is or comprises wood and/or other lignocellulosic derivatives. In some embodiments, wood derivatives may be or comprise wood flour, wood pulp, or a combination thereof.

In some embodiments, an additive is or comprises metal particles. In some embodiments, an additive is metal oxide particles. In some embodiments, metal particles are silver particles. In some embodiments, metal particles are gold particles. In some embodiments, metal oxide particles are titanium oxide particles. In some embodiments, metal oxide particles are iron oxide particles. In some embodiments, metal oxide particles are silver dioxide particles. In some embodiments, metal oxide particles are aluminum oxide particles.

In some embodiments, an additive is or comprises latex particles.

In some embodiments, an additive is or comprises one or more bioceramic materials. In some embodiments, bioceramics comprise tricalcium phosphate, a tricalcium phosphate derivative, dicalcium phosphate, a dicalcium phosphate derivative, or any combination thereof.

In some embodiments, an additive is or comprises glass materials. In some embodiments, glass materials are bioactive. In some embodiments, glass materials comprise glass fibers, glass beads, glass particles, or any combination thereof.

In some embodiments, an additive is or comprises one or more proteins. In some embodiments, a protein may be or comprise a growth factor.

In some embodiments, an additive is or comprises fluorescent dyes. In some embodiments, a fluorescent dye comprises one or more fluorescent tags.

In some embodiments, an additive is or comprises one or more minerals. In some embodiments, a mineral may be or comprise hydroxyapatite, hydroxyapatite derivatives, cement, concrete, clay, or any combination thereof.

In some embodiments, an additive may be or comprise natural fibers. In some embodiments, an additive may be or comprise polymer fibers.

In some embodiments, a lignocellulosic slurry comprises 10-95% additives by weight. For example, in some embodiments, a lignocellulosic slurry may comprise between 0% and 95% (e.g., between 0 and 90%, 0 and 80%, 0 and 70%, 0 and 60%, 0 and 50%, 0 and 40%, 0 and 30%, 0 and 20%, 0 and 10%, or 0 and 5%) wt additive(s). In some embodiments, a lignocellulosic slurry comprises at least 0.1% wt additive(s) (e.g., at least 0.5%, 1%, 5%, 10%, 15%, 20%).

In some embodiments, one or more additives modify physical, mechanical or chemical properties of a lignocellulosic composition resulting from a lignocellulosic slurry relative to an identical lignocellulosic composition resulting from a lignocellulosic slurry that lacks the one or more additives.

### Drying and Internal Void Space Formation

Drying and Microwave Radiation

The present disclosure provides methods of making a lignocellulosic composition comprising one or more cellulosic components, wherein the one or more cellulosic components comprise a micron-scale cellulose or cellulose nanofibrils (CNF), the method comprising the steps of (a) creating a lignocellulosic slurry by combining the one or more of cellulosic components with a liquid component; and (b) exposing the lignocellulosic slurry to a drying condition, thereby creating a lignocellulosic composition.

In some embodiments, a drying condition comprises one or more drying sessions. In some embodiments, one or more drying sessions are separated in time by intervals ranging from minutes to days (e.g., at least one minute, 5 minutes, 10 minutes, 20 minutes, 30 minutes, 40 minutes, 50 minutes, one hour, two hours, 24 hours, 40 hours or more).

In some embodiments, one or more drying sessions comprise identical drying conditions. In some embodiments, one or more drying sessions comprise conditions that vary in one or more parameters (e.g., time, intensity, volume of material) from at least one other drying session.

In some embodiments, a drying condition comprises microwave radiation. In some embodiments, one or more drying sessions comprise identical microwave conditions. In some embodiments, one or more drying sessions comprise microwave conditions that vary in one or more microwave parameters from at least one other drying session. In some embodiments, one or more microwave parameters comprise microwave power, microwave wavelength, microwave frequency, microwave directionality, microwave flux and duration of microwave exposure. In some embodiments, one or more drying sessions comprises one drying session and, during the one drying session, microwave radiation varies in one or more of power, wavelength, frequency, directionality and flux.

In some embodiments, microwave radiation has a power of about 5 W/kg of lignocellulosic slurry to about 100 kW/kg of lignocellulosic slurry. In some embodiments, microwave radiation has a power of about 5-90,000, 5-80,000, 5-70,000, 5-60,000, 5-50,000, 5-40,000, 5-30,000, 5-20,000, 5-10,000, 5-9,000, 5-8,000, 5-7,000, 5-6,000, 5-5,000, 5-4,000, 5-3,000, 5-2,000, 5-1,000, 5-900, 5-800, 5-700, 5-600, 5-500, 5-400, 5-300, 5-200, 5-100, 5-95, 5-90, 5-85, 5-80, 5-75, 5-70, 5-65, 5-60, 5-55, 5-50, 5-45, 5-40, 5-35, 5-30, 5-25, 5-20, 5-19, 5-18, 5-17, 5-16, 5-15, 5-14, 5-13, 5-12, 5-11, 5-10, 5-9, 5-8, 5-7, or 5-6 W/kg. In some embodiments, microwave radiation has a power of about 10-100,000, 15-100,000, 20-100,000, 25-100,000, 30-100,000, 35-100,000, 40-100,000, 45-100,000, 50-100,000, 55-100,000, 60-100,000, 65-100,000, 70-100,000, 75-100,000, 80-100,000, 85-100,000, 90-100,000, 100-100,000, 150-100,000, 200-100,000, 250-100,000, 300-100,000, 350-100,000, 400-100,000, 450-100,000, 500-100,000, 550-100,000, 600-100,000, 650-100,000, 700-100,000, 750-100,000, 800-100,000, 850-100,000, 900-100,000, 1000-100,000, 2000-100,000, 3000-100,000, 4000-100,000, 5000-100,000, 6000-100,000, 7000-100,000, 8000-100,000, 9000-100,000, 10,000-100,000, 20,000-100,000, 30,000-100,000, 40,000-100,000, 500,000-100,000, 60,000-100,000, 70,000-100,000, 80,000-100,000, or 90,000-100,000 W/kg.

In some embodiments, microwave radiation has a wavelength of about one millimeter to about one meter. In some embodiments, microwave radiation has a wavelength of about 1-900, 1-850, 1-800, 1-750, 1-700, 1-650, 1-600, 1-550, 1-500, 1-450, 1-400, 1-350, 1-300, 1-250, 1-200, 1-150, 1-100, 1-90, 1-85, 1-80, 1-75, 1-70, 1-65, 1-60, 1-55, 1-50, 1-45, 1-40, 1-35, 1-30, 1-25, 1-20, 1-19, 1-18, 1-17, 1-16, 1-15, 1-14, 1-13, 1-12, 1-11, 1-10, 1-9, 1-8, 1-7, 1-6, 1-5, 1-4, 1-3, or 1-2 millimeters. In some embodiments, microwave radiation has a wavelength of about 0.005-1, 0.01-1, 0.015-1, 0.02-1, 0.025-1, 0.03-1, 0.035-1, 0.04-1, 0.045-1, 0.05-1, 0.055-1, 0.06-1, 0.065-1, 0.07-1, 0.075-1, 0.08-1, 0.085-1, 0.09-1, 0.095-1, 0.1-1, 0.2-1, 0.25-1, 0.3-1, 0.35-1, 0.4-1, 0.45-1, 0.5-1, 0.55-1, 0.6-1, 0.65-1, 0.7-1, 0.75-1, 0.8-1, 0.85-1, or 0.9-1 meters.

In some embodiments, microwave radiation may have a frequency between 500 MHz and 100 GHz, between 500 MHz and 50 GHz, between 500 MHz and 10 GHz, or between 500 MHz and 5 GHz. In some embodiments, microwave radiation may have a frequency of 915 MHz. In some embodiments, microwave radiation may have a frequency of 2,450 MHz. In some embodiments, microwave radiation may have a frequency between 915 MHz and 2,450 MHz.

In some embodiments, a lignocellulosic slurry is exposed to microwave radiation for a duration comprising about 10 seconds to about 90 hours per kg of lignocellulosic slurry. In some embodiments, a lignocellulosic slurry is exposed to microwave radiation for a duration comprising about 10 seconds to about 80 hours. In some embodiments, a lignocellulosic slurry is exposed to microwave radiation for a duration comprising about 10 seconds to about 70 hours. In some embodiments, a lignocellulosic slurry is exposed to microwave radiation for a duration comprising about 10 seconds to about 60 hours. In some embodiments, a lignocellulosic slurry is exposed to microwave radiation for a duration comprising about 10 seconds to about 50 hours. In some embodiments, a lignocellulosic slurry is exposed to microwave radiation for a duration comprising about 10 seconds to about 40 hours. In some embodiments, a lignocellulosic slurry is exposed to microwave radiation for a duration comprising about 10 seconds to about 30 hours. In some embodiments, a lignocellulosic slurry is exposed to microwave radiation for a duration comprising about 10 seconds to about 20 hours. In some embodiments, a lignocellulosic slurry is exposed to microwave radiation for a duration comprising about 10 seconds to about 15 hours. In some embodiments, a lignocellulosic slurry is exposed to microwave radiation for a duration comprising about 10 seconds to about 10 hours. In some embodiments, a lignocellulosic slurry is exposed to microwave radiation for a duration comprising about 10 seconds to about 9 hours. In some embodiments, a lignocellulosic slurry is exposed to microwave radiation for a duration comprising about 10 seconds to about 8 hours. In some embodiments, a lignocellulosic slurry is exposed to microwave radiation for a duration comprising about 10 seconds to about 7 hours. In some embodiments, a lignocellulosic slurry is exposed to microwave radiation for a duration comprising about 10 seconds to about 6 hours. In some embodiments, a lignocellulosic slurry is exposed to microwave radiation for a duration comprising about 10 seconds to about 5 hours. In some embodiments, a lignocellulosic slurry is exposed to microwave radiation for a duration comprising about 10 seconds to about 4 hours. In some embodiments, a lignocellulosic slurry is exposed to microwave radiation for a duration comprising about 10 seconds to about 3 hours. In some embodiments, a lignocellulosic slurry is exposed to microwave radiation for a duration comprising about 10 seconds to about 2 hours. In some embodiments, a lignocellulosic slurry is exposed to microwave radiation for a duration comprising about 10 seconds to about 1 hour. In some embodiments, a lignocellulosic slurry is exposed to microwave radiation for a duration comprising about 10 seconds to about 55 minutes. In some embodiments, a lignocellulosic slurry is exposed to microwave radiation for a duration comprising about 10 seconds to about 50 minutes. In some embodiments, a lignocellulosic slurry is exposed to microwave radiation for a duration comprising about 10 seconds to about 45 minutes. In some embodiments, a lignocellulosic slurry is exposed to microwave radiation for a duration comprising about 10 seconds to about 40 minutes. In some embodiments, a lignocellulosic slurry is exposed to microwave radiation for a duration comprising about 10 seconds to about 35 minutes. In some embodiments, a lignocellulosic slurry is exposed to microwave radiation for a duration comprising about 10 seconds to about 30 minutes. In some embodiments, a lignocellulosic slurry is exposed to microwave radiation for a duration comprising about 10 seconds to about 25 minutes. In some embodiments, a lignocellulosic slurry is exposed to microwave radiation for a duration comprising about 10 seconds to about 20 minutes. In some embodiments, a lignocellulosic slurry is exposed to microwave radiation for a duration comprising about 10 seconds to about 15 minutes. In some embodiments, a lignocellulosic slurry is exposed to microwave radiation for a duration comprising about 10 seconds to about 10 minutes. In some embodiments, a lignocellulosic slurry is exposed to microwave radiation for a duration comprising about 10 seconds to about 9 minutes. In some embodiments, a lignocellulosic slurry is exposed to microwave radiation for a duration comprising about 10 seconds to about 8 minutes. In some embodiments, a lignocellulosic slurry is exposed to microwave radiation for a duration comprising about 10 seconds to about 7 minutes. In some embodiments, a lignocellulosic slurry is exposed to microwave radiation for a duration comprising about 10 seconds to about 6 minutes. In some embodiments, a lignocellulosic slurry is exposed to microwave radiation for a duration comprising about 10 seconds to about 5 minutes. In some embodiments, a lignocellulosic slurry is exposed to microwave radiation for a duration comprising about 10 seconds to about 4 minutes. In some embodiments, a lignocellulosic slurry is exposed to microwave radiation for a duration comprising about 10 seconds to about 3 minutes. In some embodiments, a lignocellulosic slurry is exposed to microwave radiation for a duration comprising about 10 seconds to about 2 minutes. In some embodiments, a lignocellulosic slurry is exposed to microwave radiation for a duration comprising about 10 seconds to about 1 minute. In some embodiments, a lignocellulosic slurry is exposed to microwave radiation for a duration comprising about 10 seconds to about 55 seconds. In some embodiments, a lignocellulosic slurry is exposed to microwave radiation for a duration comprising about 10 seconds to about 50 seconds. In some embodiments, a lignocellulosic slurry is exposed to microwave radiation for a duration comprising about 10 seconds to about 45 seconds. In some embodiments, a lignocellulosic slurry is exposed to microwave radiation for a duration comprising about 10 seconds to about 40 seconds. In some embodiments, a lignocellulosic slurry is exposed to microwave radiation for a duration comprising about 10 seconds to about 35 seconds. In some embodiments, a lignocellulosic slurry is exposed to microwave radiation for a duration comprising about 10 seconds to about 30 seconds. In some embodiments, a lignocellulosic slurry is exposed to microwave radiation for a duration comprising about 10 seconds to about 25 seconds. In some embodiments, a lignocellulosic slurry is exposed to microwave radiation for a duration comprising about 10 seconds to about 20 seconds. In some embodiments, a lignocellulosic slurry is exposed to microwave radiation for a duration comprising about 10 seconds to about 19 seconds. In some embodiments, a lignocellulosic slurry is exposed to microwave radiation for a duration comprising about 10 seconds to about 18 seconds. In some embodiments, a lignocellulosic slurry is exposed to microwave radiation for a duration comprising about 10 seconds to about 17 seconds. In some embodiments, a lignocellulosic slurry is exposed to microwave radiation for a duration comprising about 10 seconds to about 16 seconds. In some embodiments, a lignocellulosic slurry is exposed to microwave radiation for a duration comprising about 10 seconds to about 15 seconds. In some embodiments, a lignocellulosic slurry is exposed to microwave radiation for a duration comprising about 10 seconds to about 14 seconds. In some embodiments, a lignocellulosic slurry is exposed to microwave radiation for a duration comprising about 10 seconds to about 13 seconds. In some embodiments, a lignocellulosic slurry is exposed to microwave radiation for a duration comprising about 10 seconds to about 12 seconds. In some embodiments, a lignocellulosic slurry is exposed to microwave radiation for a duration comprising about 10 seconds to about 11 seconds.

In some embodiments, a lignocellulosic slurry is contained in a mold when exposed to microwave radiation for at least one drying session (e.g., microwave radiation session). In some embodiments, a lignocellulosic slurry is not contained in a mold when exposed to the microwave radiation for at least one drying session. In some embodiments, a lignocellulosic slurry is extruded when exposed to microwave radiation for at least one drying session. In some embodiments, a mold is cylindrical. In some embodiments, a mold is a sphere, cone, cube, sheet or thin film. In some embodiments, a mold (and a lignocellulosic composition (e.g., foam) that has been shaped by the mold) may be regular in shape. In some embodiments, a mold (and a lignocellulosic composition (e.g., foam) that has been shaped by the mold) may be irregular in shape. In some embodiments, the shape of a lignocellulosic composition may be modified or altered relative to the shape of mold if, between a first and a second drying condition, a semi-solid composition is removed from a mold while it is still somewhat malleable (e.g., up to about 80% water by weight). In some embodiments, a semi-solid composition may be shaped into a non-mold shape before the composition is dried to completion in a subsequent drying condition. In some embodiments, a semi-solid composition can be shaped into a form and then exposed, mold-free, to a drying condition to obtain a desired shape.

In some embodiments, the lignocellulosic slurry is exposed to the microwave radiation until the liquid component content is between about 0.01% to about 20% by weight (e.g., between 0.05 to 20%, 0.05 to 10%, 0.1 to 20%, 0.1 to 10%, 1 to 20%, 1 to 15%, 1 to 10%, 1 to 5% by weight).

In some embodiments, methods of making a lignocellulosic composition further comprises a step of exposing a first lignocellulosic composition to a second drying condition, thereby creating a second lignocellulosic composition. In some embodiments, a second drying condition comprises thermal energy, vacuum, lyophilization or air drying. In some embodiments, a second drying condition induces a different rate of liquid component removal than a first drying condition. In some embodiments, a second lignocellulosic composition comprises different material properties compared to a first lignocellulosic composition. In some embodiments, a second lignocellulosic composition comprises a lower liquid component content by weight compared to a first lignocellulosic composition.

In some embodiments, methods of making a lignocellulosic composition further comprise a step of covering a first lignocellulosic composition or covering a second lignocellulosic composition with a layer of a shell material, thereby creating a dried lignocellulosic composition with an outer layer of shell material. In some embodiments, methods of making a lignocellulosic composition further comprise a step of exposing a dried lignocellulosic composition with an outer layer of shell material to a third drying condition, thereby creating a dried lignocellulosic composition with an outer layer of dried shell material. In some embodiments, an outer layer of dried shell material is more dense than a first lignocellulosic composition and/or more dense a second lignocellulosic composition. In some embodiments, an outer layer of dried shell material is less dense than a first lignocellulosic composition and/or less dense that a second lignocellulosic composition. In some embodiments, a shell material is or comprises CNF, wood derivatives, metal particles, latex particles, bioceramics, glass materials, proteins, fluorescent dyes, minerals, natural fibers, polymer materials, or any combination thereof. In some embodiments, a third drying condition is or comprises microwave radiation, thermal energy, vacuum, lyophilization or air drying.

Internal Void Space Formation

In some embodiments, the present disclosure provides compositions comprising significant internal void space relative to continuous solid material and methods for making said compositions. In general, materials of the present disclosure do not have regular, idealized, cylindrical channels running through the material. In accordance with various embodiments, materials of the present disclosure can be described as comprising an open web of cellulose and, in some embodiments, other components. Materials of the present disclosure do not comprise traditional pores, if pores are defined as minute openings, especially in an animal or plant, by which matter passes, for example, through a membrane. In accordance with various embodiments, materials of the present disclosure do not predominantly contain smooth, more spherical pores, often referred to as ‘cells’. In some embodiments, materials of the present disclosure do not contain substantial amounts of spherical pores. Additionally, in some embodiments, materials (e.g., compositions) of the present disclosure do not comprise pores created by the method of porogen leaching (e.g., for preparing porous scaffolds). However, the present disclosure may include “porosity” or “void fraction” as a measure to describe the internal void space of a material of the present invention. In some embodiments, a void fraction is calculated using the following equation: Vf=(1−1/Φ)×100, wherein Vf is void fraction and Φ is expansion ratio.

In some embodiments, variation in microwave radiation (e.g., during one or more drying sessions) results in a lignocellulosic composition having variable internal void space per volume. In some embodiments, variation in microwave radiation results in a lignocellulosic composition having variable porosity. In some embodiments, variation in microwave radiation results in a lignocellulosic composition having homogenous internal void space per volume. In some embodiments, variation in microwave radiation results in a lignocellulosic composition having homogenous porosity.

In some embodiments, exposing a lignocellulosic slurry to a first drying condition comprises individual cellulose (e.g., CNF) molecules and water molecules moving (e.g., rotating, flexing, bending) in such a way as to sample their local environment and to find those points of contact with other cellulose molecules that maximize the total bond energy of the entire CNF-CNF or CNF-cellulose hydrogen bonding network. The present disclosure encompasses the surprising recognition that a water removal process that proceeds too quickly, or in a way in which either the water molecules or the CNF/cellulose material molecules or surface moieties are inhibited from moving and cannot establish an optimal hydrogen bonding network, can result in a relatively weak and inferior material. The present disclosure provides a separation of cellulose and/or CNF by using microwave energy while binding them in place in the expanded state using enhanced H-bonding.

In some embodiments, water removal during a first drying condition is best modeled by the enthalpy of vaporization of water (Hvap), wherein primarily water-water hydrogen bonds are broken. Relative to an open water surface, the time constant for this process is significantly increased due to the hindered transport of water through the cellulose/CNF network. However, in some embodiments, the time constant can still be dramatically reduced at elevated temperatures (e.g., 25-65° C.). Below 40% water by weight, the water removal process is further hindered as the cellulose-cellulose (e.g., CNF-CNF) network continues to contract, leaving only micropores for water transport. Additionally, much of the remaining water is associated with the cellulose (e.g., CNF) network through cellulose-water hydrogen bonds, which requires additional energy for removal. Below about 5% water by weight, complete and permanent water removal is extremely difficult because the released water molecules move in a stick-release pattern from one cellulose to another open cellulose hydrogen binding site. Depending on the final desired internal void space by volume (e.g., porosity), water removal during a first drying condition can be ended at any point, and complete water removal, at a fixed final internal void space by volume (i.e., porosity), can be achieved through a second drying condition.

In some embodiments, further drying (e.g., drying occurring after a first drying session) may optionally occur during a second drying session. In an exemplary second drying session, a first lignocellulosic composition (the results of a first drying session) can be removed from a mold and suspended in a temperature- and humidity-controlled environment, wherein continued water removal is achieved by evaporation. In some embodiments, a second drying session continues until the water content of the lignocellulosic composition is about 0.01 to about 10% by weight, depending on the desired physical and mechanical properties of a final composition. In some embodiments, as water is removed from a lignocellulosic composition, the volume of the lignocellulosic composition deceases significantly.

In some embodiments, a process of exposing a lignocellulosic slurry to one or more drying conditions can achieve a lignocellulosic composition comprising about 95% cellulosic solids by weight.

### Lignocellulosic Foam Compositions

The present disclosure provides, inter alia, processes for efficiently fully or partially drying lignocellulosic slurries comprising CNF. In some embodiments, a process of the present disclosure provides a lignocellulosic composition comprising a lignocellulosic foam. The present disclosure also provides, in some embodiments, compositions comprising cellulose (e.g., lignocellulosic compositions), wherein the lignocellulosic compositions have an internal void space of about 5% to about 95% by volume. In some embodiments, a lignocellulosic composition has an internal void space of about 5, 10, 15, 20, 25, 30, 35, 40, 45, 50, 55, 60, 65, 70, 75, 80, 85, 90, or 95% internal void space by volume. In some embodiments, a lignocellulosic composition has an internal void space of about 5-90%, 5-85%, 5-80%, 5-75%, 5-70%, 5-65%, 5-60%, 5-55%, 5-50%, 5-45%, 5-40%, 5-35%, 5-30%, 5-25%, 5-20%, 5-15%, 5-10%, 5-9%, 5-8%, 5-7%, or 5-6% by volume. In some embodiments, a lignocellulosic composition has an internal void space of about 10-95%, 15-95%, 20-95%, 25-95%, 30-95%, 35-95%, 40-95%, 45-95%, 50-95%, 55-95%, 60-95%, 65-95%, 70-95%, 75-95%, 80-95%, 85-95%, 90-95%, 91-95%, 92-95%, 93-95%, or 94-95% by volume.

In some embodiments, a lignocellulosic composition has a density of about 0.02 g/cm³ to about 5 g/cm³. In some embodiments, a lignocellulosic composition has a density of about 0.3, 0.5, 1.0, 1.5, 2.0, 2.5, 3.0, 3.5, 4.0, 4.5 or 5.0 g/cm³. In some embodiments, a lignocellulosic composition has a density from about 0.3-5.0, 0.5-5.0, 1.0-5.0, 1.5-5.0, 2.0-5.0, 2.5-5.0, 3.0-5.0, 3.5-5.0, 4.0-5.0, or 4.5-5.0 g/cm³.

In some embodiments, a lignocellulosic composition has a nanocellulose fiber solids content of about 1% by weight to about 95% by weight. In some embodiments, a lignocellulosic composition has a nanocellulose fiber solids content of about 1, 5, 10, 15, 20, 25, 30, 35, 40, 45, 50, 55, 60, 65, 70, 75, 80, 85, 90, or 95% by weight. In some embodiments, a lignocellulosic composition has a nanocellulose fiber solids content of about 1-90%, 1-85%, 1-80%, 1-75%, 1-70%, 1-65%, 1-60%, 1-55%, 1-50%, 1-45%, 1-40%, 1-35%, 1-30%, 1-25%, 1-20%, 1-15%, 1-10%, 1-9%, 1-8%, 1-7%, 1-6%, 1-5%, 1-4%, 1-3%, or 1-2% by weight. In some embodiments, a lignocellulosic composition has a nanocellulose fiber solids content of about 1-95%, 5-95%, 10-95%, 15-95%, 20-95%, 25-95%, 30-95%, 35-95%, 40-95%, 45-95%, 50-95%, 55-95%, 60-95%, 65-95%, 70-95%, 75-95%, 80-95%, 85-95%, 90-95%, 91-95%, 92-95%, 93-95%, or 94-95% by weight.

In some embodiments, internal void space is distributed homogenously or substantially homogenously throughout the composition. In some embodiments, internal void space is distributed variably across at least two regions of the composition. In some embodiments, at least two regions comprise a first region having a first internal void space by volume and a second region having a second internal void space by volume. In some embodiments, there is a gradual change in internal void space by volume from the first region to the second region. In some embodiments, there is a step-wise change in internal void space by volume from the first region to the second region. In some embodiments, a first region is interior relative to the second region in the lignocellulosic composition. In some embodiments, a second region is interior relative to the first region in the lignocellulosic composition. In some embodiments, a first region is layered horizontally relative to the second region in the lignocellulosic composition. In some embodiments, a first internal void space by volume is less than the second internal void space by volume.

In some embodiments, a lignocellulosic composition of the present disclosure further comprises one or more additives. In some embodiments, one or more additives modify physical, mechanical or chemical properties of a lignocellulosic composition relative to an identical lignocellulosic composition lacking the one or more additives. In some embodiments, one or more additives comprise wood derivatives, metal particles, latex particles, bioceramics, glass materials, proteins, fluorescent dyes, minerals, natural fibers, polymer materials, or any combination thereof.

In some embodiments, a lignocellulosic slurry comprises one or more additives. In some embodiments, an additive is or comprises wood derivatives. In some embodiments, wood derivatives comprise wood flour, wood pulp, or a combination thereof.

In some embodiments, an additive is or comprises metal particles. In some embodiments, an additive is or comprises metal oxide particles. In some embodiments, metal particles are silver particles. In some embodiments, metal particles are gold particles. In some embodiments, metal oxide particles are titanium oxide particles. In some embodiments, metal oxide particles are iron oxide particles. In some embodiments, metal oxide particles are silver dioxide particles. In some embodiments, metal oxide particles are aluminum oxide particles.

In some embodiments, an additive is or comprises latex particles.

In some embodiments, an additive is or comprises one or more bioceramic materials. In some embodiments, a bioceramic material is or comprises one or more of tricalcium phosphate, a tricalcium phosphate derivative, dicalcium phosphate, a dicalcium phosphate derivative, or any combination thereof.

In some embodiments, an additive is or comprises one or more glass materials. In some embodiments, glass materials are bioactive. In some embodiments, glass materials comprise glass fibers, glass beads, glass particles, or any combination thereof.

In some embodiments, an additive is or comprises one or more proteins. In some embodiments, proteins comprise growth factors.

In some embodiments, an additive is or comprises one or more fluorescent dyes. In some embodiments, a fluorescent dye comprises one or more fluorescent tags.

In some embodiments, an additive comprises one or more minerals. In some embodiments, a mineral may be or comprise hydroxyapatite, hydroxyapatite derivatives, cement, concrete, clay, or any combination thereof.

In some embodiments, an additive comprises one or more natural fibers. In some embodiments, an additive comprises polymer fibers.

Other additives are known to those skilled in the art and could be considered for addition to the structural products of the invention without deviating from the scope of the invention.

In some embodiments, one or more additives may be present in concentrations varying from about 0.01% by weight to about 80% by weight. In some embodiments, one or more additives may be present in concentrations varying from about 0.01-75%, 0.01-70%, 0.01-65%, 0.01-60%, 0.01-55%, 0.01-50%, 0.01-45%, 0.01-40%, 0.01-35%, 0.01-30%, 0.01-25%, 0.01-20%, 0.01-15%, 0.01-10%, 0.01-5%, 0.01-1%, 0.01-0.5%, 0.01-0.1%, 0.01-0.09%, 0.01-0.08%, 0.01-0.07%, 0.01-0.06%, 0.01-0.05%, 0.01-0.04%, 0.01-0.03%, or 0.01-0.02% by weight. In some embodiments, one or more additives may be present in concentrations varying from about 0.05-80%, 0.1-80%, 0.5-80%, 1-80%, 5-80%, 10-80%, 15-80%, 20-80%, 25-80%, 30-80%, 35-80%, 40-80%, 45-80%, 50-80%, 55-80%, 60-80%, 65-80%, 70-80%, 71-80%, 72-80%, 73-80%, 74-80%, 75-80%, 76-80%, 77-80%, 78-80%, or 79-80% by weight.

An exemplary additive that imparts a different physical property to a composition (e.g., as compared to the composition without the additive) is the addition of super-paramagnetic iron oxide nanoparticles (SPMNP) to a lignocellulosic slurry. As the slurry is dried, the SPMNP become trapped within a web of cellulose (e.g., nanocellulose) which permits imaging of the structure in biomedical applications, in-situ, by means of magnetic resonance imaging (MM) equipment. Furthermore, if the product is one designed intentionally to disintegrate over time and be resorbed, this disintegration may be imaged and monitored via the localized loss of SPMNP-induced contrast as imaged by MRI.

An exemplary additive that imparts a change in a chemical property of a composition is the addition of a reagent to a lignocellulosic structure. Reagents in biomedical applications may include drugs such as antibiotics or immunosuppressive drugs. Reagents in diagnostic applications may include analyte capture reagents such as antibodies or fragments thereof. Reagents in environmental applications may include any chemical reagents known to react with and detect the presence of an environmental contaminant or other analyte. Through the control of disintegration characteristics and porosity, the reagents may be gradually released into the surroundings.

In some embodiments, the present disclosure comprises biocompatible structural products that consist essentially of nanocellulose fibers. The term “consisting essentially of” means that the base products are composed of at least 99.0% nanocellulose by weight. However, “consisting essentially of” does not exclude the presence of other additives in addition to the base product that are present to impart particular physical or chemical properties to the nanocellulose, as described herein. As used herein, “biocompatible” means that the base CNF products are “medically compatible” in that they elicit little or no immune rejection response when inserted in or placed in contact with the body; or that they are “environmentally compatible” in that they produce or leave no hazardous or non-biodegradable residue.

Exemplary biomedical uses of compositions of the present disclosure comprise temporary replacements or scaffolds for bone, cartilage, dermis, vasculature or any combination thereof.

### Physical Properties

The present disclosure provides lignocellulosic compositions comprising various physical properties. The present disclosure provides lignocellulosic compositions comprising various mechanical properties. In some embodiments, a physical property comprises internal void space by volume. In some embodiments, a physical property comprises porosity. In some embodiments, a physical property comprises distribution of internal void space. In some embodiments, a physical property comprises biocompatibility. In some embodiments, a physical property comprises hydrophobicity. In some embodiments, a mechanical property comprises density. In some embodiments, a mechanical property comprises dissolution kinetics. In some embodiments, a mechanical property comprises flexure strength. In some embodiments, a mechanical property comprises compressive modulus.

In some embodiments, a lignocellulosic composition has a density between about 0.02 g/cm³ and about 2.5 g/cm³. In some embodiments, a lignocellulosic composition has a density between about 0.02-2.4, 0.02-2.3, 0.02-2.2, 0.02-2.1, 0.02-2.0, 0.02-1.9, 0.02-1.8, 0.02-1.7, 0.02-1.6, 0.02-1.5, 0.02-1.4, 0.02-1.3, 0.02-1.2, 0.02-1.1, 0.02-1.0, 0.02-0.9, 0.02-0.8, 0.02-0.7, 0.02-0.6, 0.02-0.5, 0.02-0.4, 0.02-0.3, 0.02-0.2, 0.02-0.1, 0.02-0.09, 0.02-0.08, 0.02-0.07, 0.02-0.06, 0.02-0.05, 0.02-0.04, or 0.02-0.03 g/cm³. In some embodiments, a lignocellulosic composition has a density between about 0.03-2.5, 0.04-2.5, 0.05-2.5, 0.06-2.5, 0.07-2.5, 0.08-2.5, 0.09-2.5, 0.1-2.5, 0.2-2.5, 0.3-2.5, 0.4-2.5, 0.5-2.5, 0.6-2.5, 0.7-2.5, 0.8-2.5, 0.9-2.5, 1.0-2.5, 1.1-2.5, 1.2-2.5, 1.3-2.5, 1.4-2.5, 1.5-2.5, 1.6-2.5, 1.7-2.5, 1.8-2.5, 1.9-2.5, 2.0-2.5, 2.1-2.5, 2.2-2.5, 2.3-2.5, or 2.4-2.5 g/cm³.

In some embodiments, a lignocellulosic composition has dissolution kinetics between about 0.00000001 g/cm²/minute-0.00001 g/cm²/minute.

In some embodiments, a lignocellulosic composition has a flexural modulus between about 100 kPa and about 2500 MPa. In some embodiments, a lignocellulosic composition has a flexural modulus between about 0.1-2000, 0.1-1500, 0.1-1000, 0.1-900, 0.1-800, 0.1-700, 0.1-600, 0.1-500, 0.1-400, 0.1-300, 0.1-200, 0.1-100, 0.1-90, 0.1-80, 0.1-70, 0.1-60, 0.1-50, 0.1-40, 0.1-30, 0.1-20, 0.1-10, 0.1-1, 0.1-0.9, 0.1-0.8, 0.1-0.7, 0.1-0.6, 0.1-0.5, 0.1-0.4, 0.1-0.3, or 0.1-0.2 MPa. In some embodiments, a lignocellulosic composition has a flexural modulus between about 0.5-2500, 1-2500, 50-2500, 100-2500, 150-2500, 200-2500, 250-2500, 300-2500, 350-2500, 400-2500, 450-2500, 500-2500, 550-2500, 600-2500, 650-2500, 700-2500, 750-2500, 800-2500, 850-2500, 900-2500, 950-2500, 1000-2500, 1100-2500, 1200-2500, 1300-2500, 1400-2500, 1500-2500, 1600-2500, 1700-2500, 1800-2500, 1900-2500, 2000-2500, 2100-2500, 2200-2500, 2300-2500, or 2400-2500 MPa.

In some embodiments, a lignocellulosic composition has a compression strength between about 10 kPa and about 100 MPa. In some embodiments, a lignocellulosic composition has a compression strength between about 0.01-90, 0.01-85, 0.01-80, 0.01-75, 0.01-70, 0.01-65, 0.01-60, 0.01-55, 0.01-50, 0.01-45, 0.01-40, 0.01-35, 0.01-30, 0.01-25, 0.01-20, 0.01-15, 0.01-10, 0.01-5, 0.01-1, 0.01-0.9, 0.01-0.8, 0.01-0.7, 0.01-0.6, 0.01-0.5, 0.01-0.4, 0.01-0.3, 0.01-0.2, 0.01-0.1, 0.01-0.09, 0.01-0.08, 0.01-0.07, 0.01-0.06, 0.01-0.05, 0.01-0.04, 0.01-0.03, or 0.01-0.02 MPa. In some embodiments, a lignocellulosic composition has a compression strength between about 0.05-100, 0.1-100, 0.5-100, 1-100, 5-100, 10-100, 15-100, 20-100, 25-100, 30-100, 35-100, 40-100, 45-100, 50-100, 55-100, 60-100, 65-100, 70-100, 75-100, 80-100, 85-100, 90-100, 91-100, 92-100, 93-100, 94-100, 95-100, 96-100, 97-100, 98-100, or 99-100 MPa.

### EXAMPLES

The following examples are provided so as to describe to the skilled artisan how to make and use methods and compositions described herein, and are not intended to limit the scope of the present disclosure.

### Example 1: Using CNF Fibers as a Binding Agent for Lignocellulosic Foams

Microwave radiation was used to create low-density foamed structures for wood-based insulation panels for multiple applications. The main components used to produce the panels were fiber from thermomechanical pulping (TMP), with cellulose nanofibrils (CNF) as a binder (5-10% wt). The initial solid content of cellulose nanofibrils was 3% and additional water was added to the system depending on the amount of TMP fiber. Water acted as a foaming agent allowing the formation of low-density porous panels.

In one particular embodiment, 17 g of water was added for each gram of dry mass TMP fiber. The process began by diluting the CNF suspension with water based on the amount of TMP fiber present. The TMP fiber was added gradually to the diluted CNF while the mixture was continuously stirred. When the mixing process was complete, the mixture was placed into a cylindrical mold to form the desired shape before drying. For this composition, the moisture content level beyond which a desired shape cannot be maintained when a mold is removed was determined to be 95%. A cold pressure was applied using a manual hydraulic pump to adjust the target density of the lignocellulosic foam panels through removing some of the water. The dry mass of material (TMP fiber and CNF) required for a specific target density was calculated according to Equation 1:

$$Dry mass ( g ) = Target density ( \frac{g}{{cm}^{3}} ) \times Target volume ( {cm}^{3} )$$

Once the shape was formed, the mold was gently removed and the sample was placed in a microwave onto 2-3 layers of paper towels to absorb excess water. The drying process included three stages that differed in their power output. The first stage, 30% power (360 W), enabled the water to gently migrate from the core of the composition to the surface without affecting the structural integrity of the panel. This stage lasted from 4 to 8 minutes depending on the target density. For low-density (about 0.10-0.15 g/cm³) compositions, 6-8 minutes is adequate for the duration of the first stage, while for high-density (0.2-0.25 g/cm³) compositions, a shorter time was needed (4-5 minutes). This is due to the reduced amount of water removed from the high-density panels during hydraulic pressing (to increase the density). In the second stage, at 50% power (600 W), water was removed at a faster pace while maintaining the shape of the composition. It is important to note that if the composition was dried at 50% power in the first stage, the compositions would lose structural integrity due to the increased speed of water migration. The second stage lasted 1-3 minutes depending on the density of the composition. To avoid burning the sample from the core, the power output was reduced in the third (and final) stage to 30% (360 W). The final stage lasted 1-4 minutes or until drying was complete (i.e., moisture content of about 5-8%). The dried samples were cooled and subsequently trimmed and/or sanded if necessary.

### Example 2: Creating Insulation Foam from Wood Fibers, Using CNF as a Binder

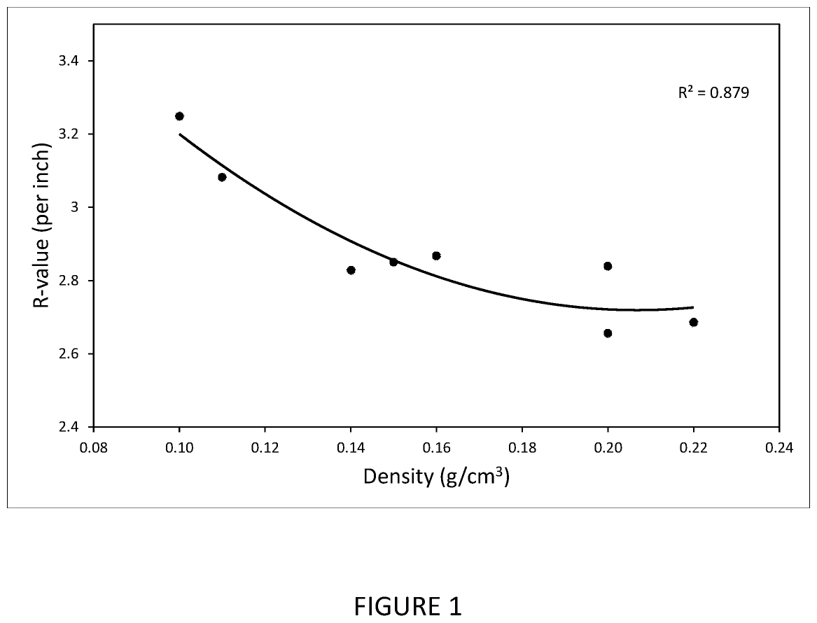

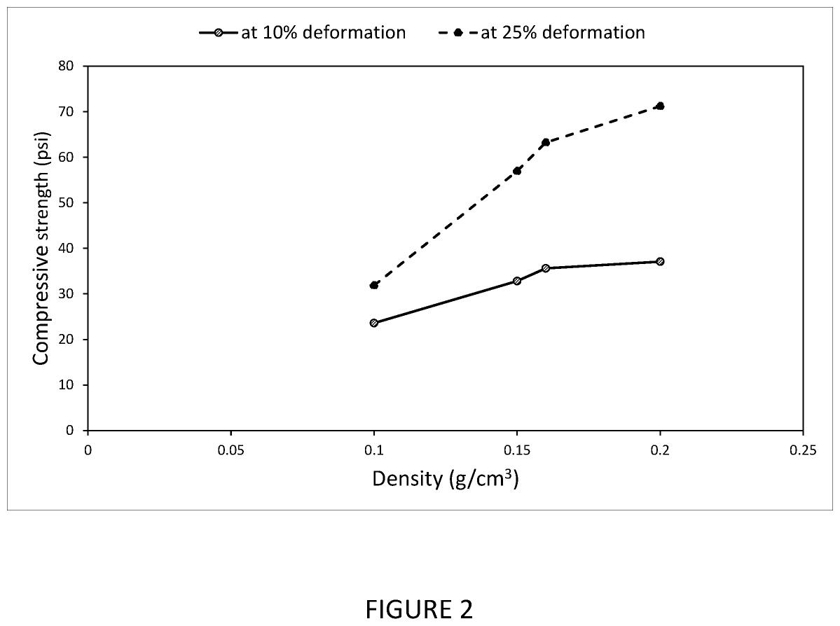

The formation and characterization of foam from wood fiber and cellulose nanofibrils (CNF) using microwave radiation was explored. Three loads of CNF binder were investigated: 5%, 10%, and 20%. It was found that a minimum of 5% CNF was adequate to produce structurally-sound compositions with a density of as low as 0.10 g/cm³. The examined densities using the 5% CNF binder load ranged from 0.10 to 0.22 cm³ with respective R-values (measure of resistance to heat flow through a given thickness of material) of 3.2 to 2.7 per inch. An overall negative correlation between the density and R-value was observed with a coefficient of determination (R²) of 0.88 (FIG. 1). FIG. 2 shows compressive strength values of the composition at 10% and 25% deformation as a function of density for a composition comprising a 5% CNF binder load.

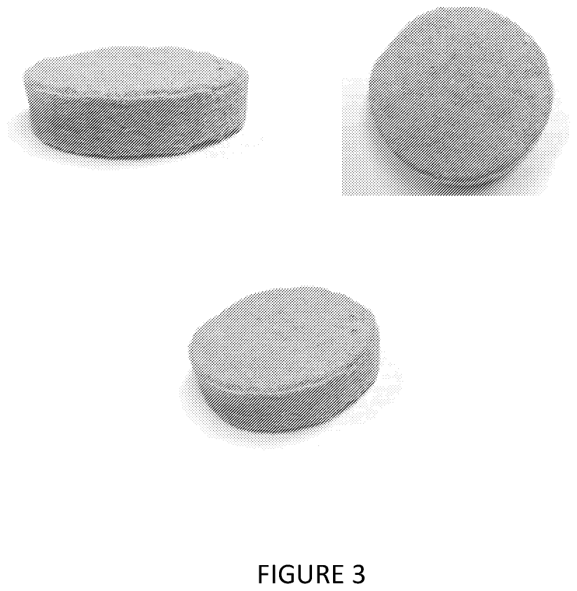

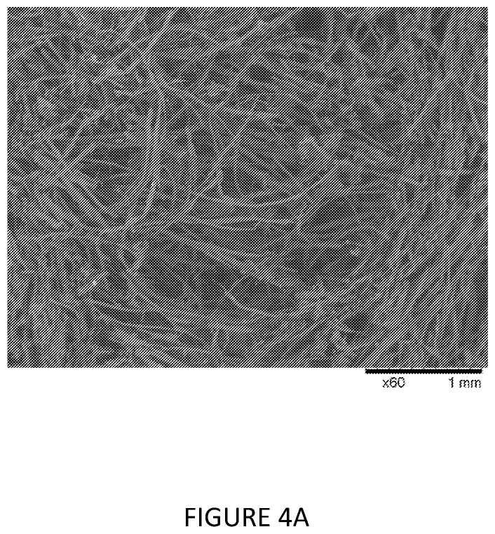

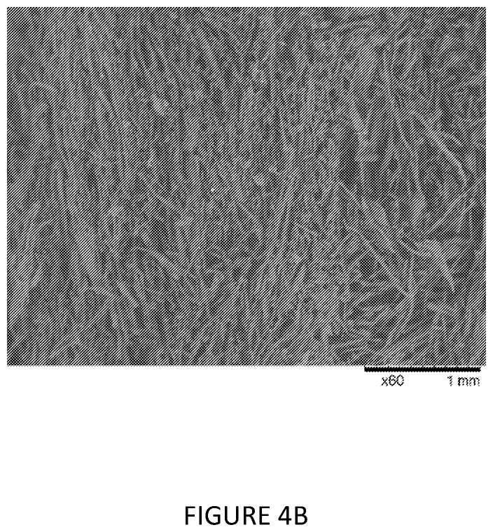

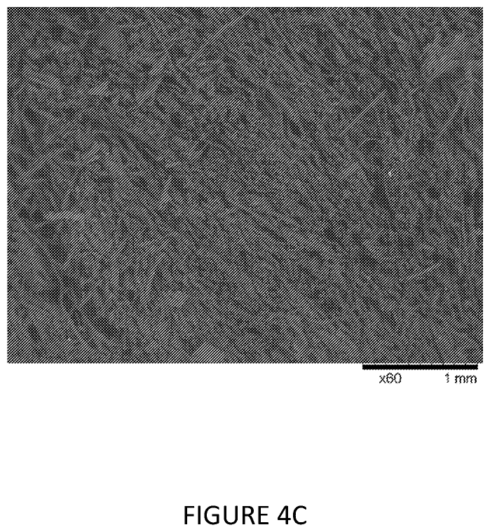

Upon the complete water removal, a hard outer layer formed on the surface of the composition. This layer can be removed during trimming or sanding without affecting the structural integrity of the panel (FIG. 3). FIG. 3 shows trimmed and sanded panels comprising a density of 0.20 g/cm³). Scanning electron microscopy images (FIGS. 4A, 4B and 4C) revealed the difference in pore structures for low, medium, and high-density panels. FIG. 4A shows a scanning electron microscopy image at 60× magnification of a 0.11 g/cm³ panel. FIG. 4B shows a scanning electron microscopy image at 60× magnification of a 0.14 g/cm³ panel. FIG. 4C shows a scanning electron microscopy image at 60× magnification of a 0.22 g/cm³ panel. The images also illustrate that the dense domains were located towards the edges while the less dense domains were located in the center, especially in the low-density panels.

### Example 3: Creating Porous Structures Via Microwave Radiation

For Phase 1 of the process, a CNF slurry was placed into a vessel or microwave-safe mold. It was ensured that there were no large air pockets in the CNF slurry, in order to produce a homogeneous foam. In slurries of a low % wt of water, molds are not necessary. The vessel containing the CNF slurry was then placed into a microwave and time and power levels were set. After the microwaving process, the composition was removed from the microwave and allowed to cool to room temperature. The CNF composition was then gently separated from the vessel with a thin metal spatula and inverted onto a thick, industrial-grade, aluminum pan lined with freezer paper. The CNF composition was then placed in a −80° C. freezer, which allowed the structure to lock into place and prevent it from collapsing. After a set amount of time, the CNF composition was removed from the freezer.

Phase 2 of the process involved removing the remaining water from the CNF composition produced by Phase 1. The frozen CNF composition produced by Phase 1 was placed in an alcohol bath for a set amount of time to allow for an exchange between water and ethanol in the CNF composition. Depending on the sample size, this exchange process took approximately 2 to 3 days. The CNF composition was then removed from the alcohol bath and placed on a fire brick and put into a convection oven at 100° C. The CNF composition was left in the oven until all the liquid component was removed and the composition was dry.

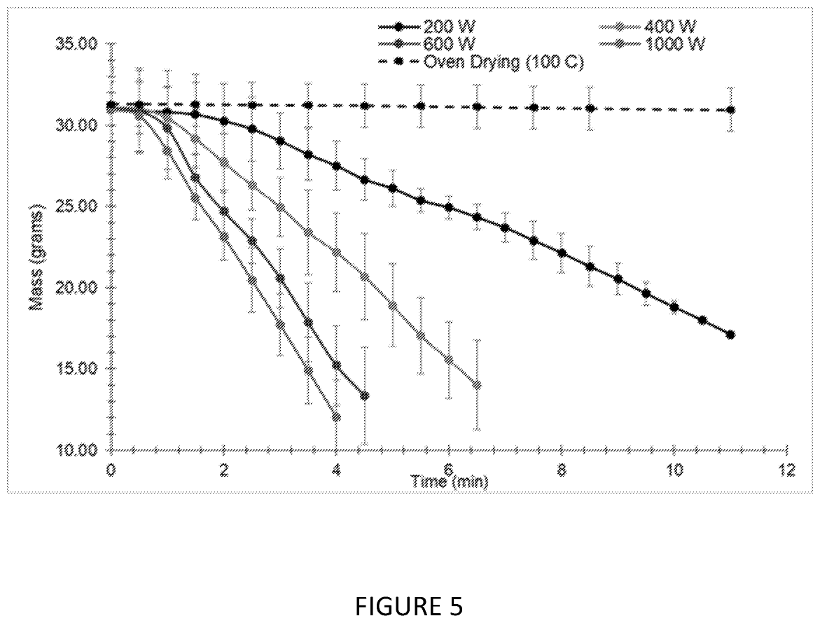

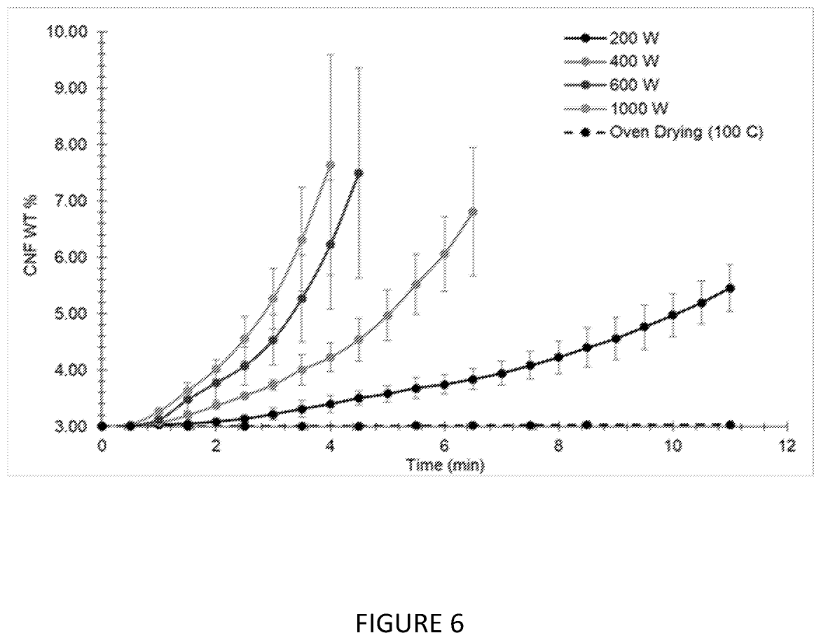

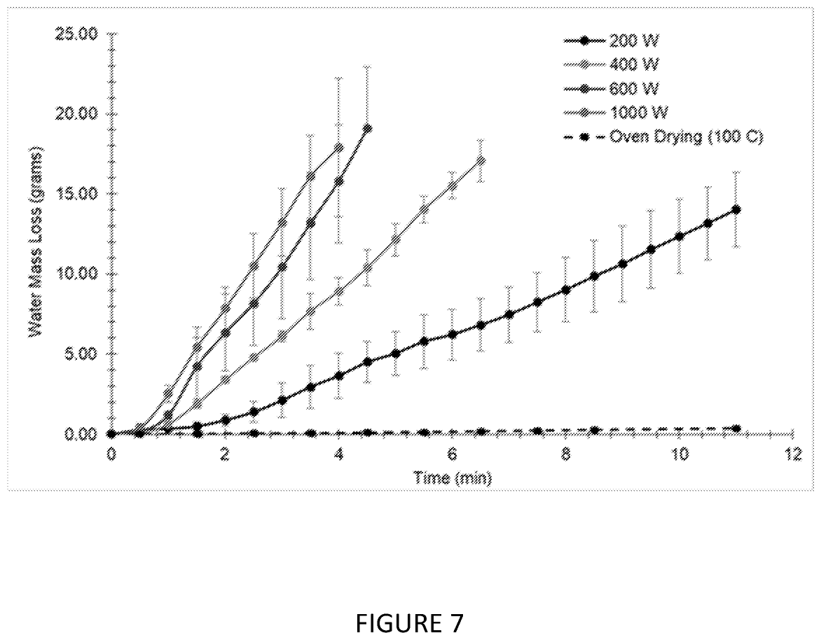

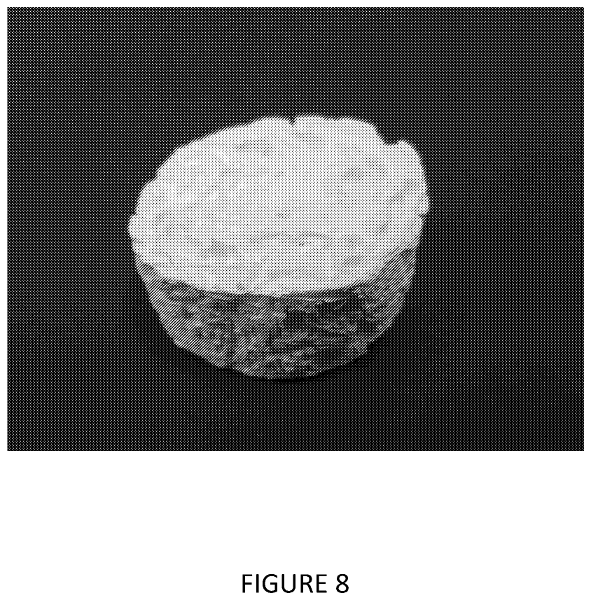

FIGS. 5-8 illustrate the advantage of drying CNF slurries via microwave radiation over using a traditional convection oven set to 100° C. At the microwave's lowest setting (200 W), energy is still transferred to the slurry more efficiently than traditional methods. The result is not only faster drying of materials, but the rapid phase change of water creates the void space characteristics and fiber orientations desired for light, structural foams. The graph in FIG. 5 shows the mass of CNF slurries over time when dried with different energy outputs. The graph in FIG. 6 shows the percent weight of nanocellulose fibers over time when dried with different energy outputs. The graph in FIG. 7 shows the water mass lost from slurries over time when dried with different energy outputs. FIG. 8 shows a nanocellulose foam that resulted from using microwave radiation for pore formation and initial drying.

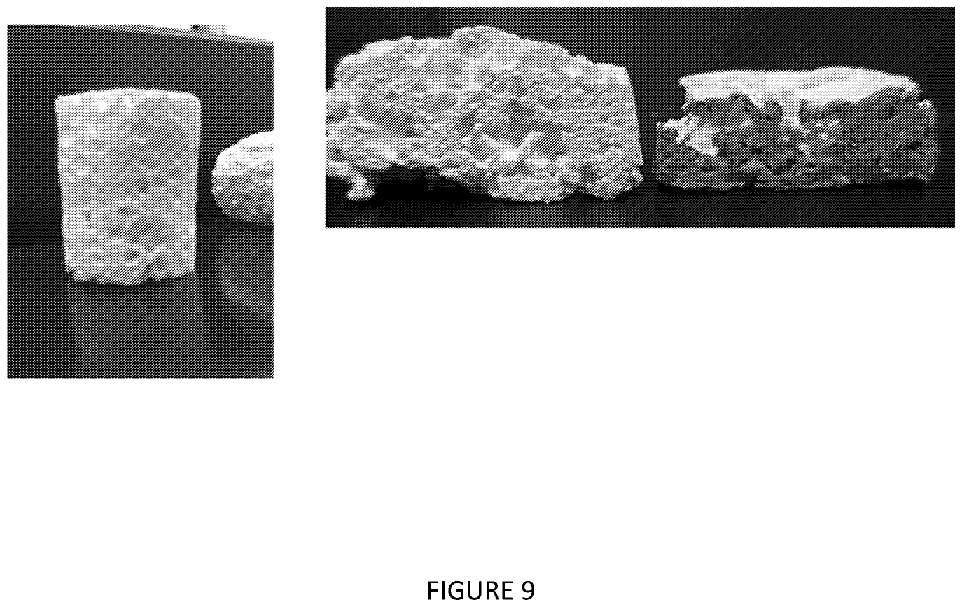

Additionally, FIG. 9 illustrates a pure very low-density (<0.05 g/cm³) CNF foam material. The cross-sectional views, including the ‘color stamped’ surface are illustrate the macroporous and microporous structure attainable by this method. Compositions of this type are generally prepared with an initial microwave radiation dose, which establishes the low-density pore network and results in a partial reduction in water content, followed by a second drying step, involving heating or lyophilization, to fully dry the material.

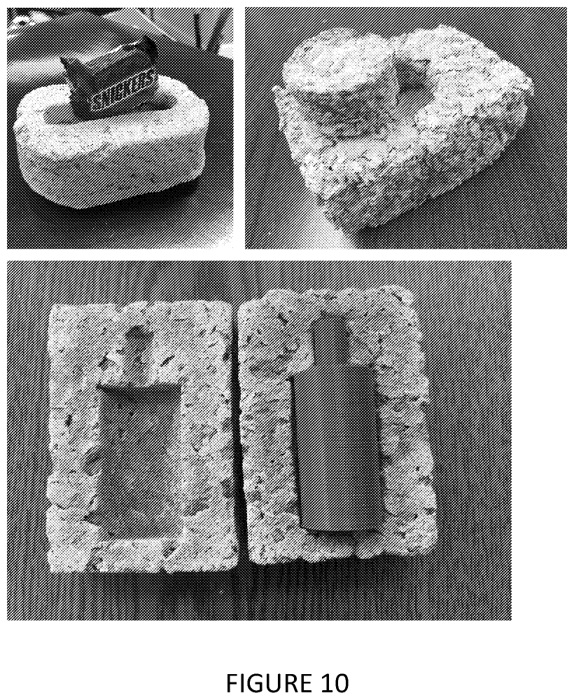

FIG. 10 illustrates low-density (0.2 g/cm³) CNF/wood residue foam compositions. Compositions of this type are generally prepared with an initial microwave radiation dose, which establishes the low-density pore network and then microwave radiation is then further used to fully dry the composition.

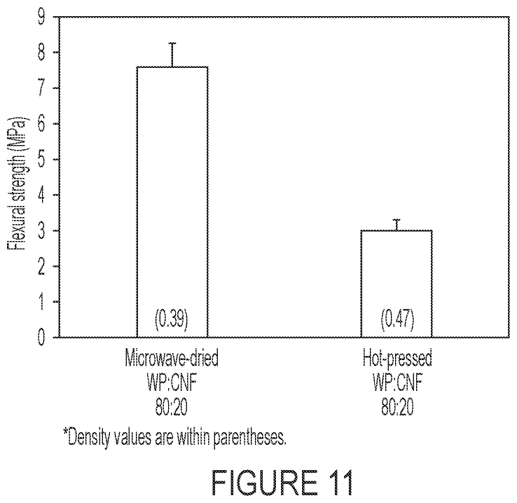

FIG. 11 shows a bar chart comparing the flexural strength of foam materials manufactured using traditional hot-press methods (i.e., at a temperature of 180° C. for 10 minutes under a pressure of about 5 MPa), compared to those prepared using the microwave-assisted method. Unexpectedly, while the microwave-assisted samples are actually lower in density, they are higher in strength.

### EQUIVALENTS

It is to be appreciated by those skilled in the art that various alterations, modifications, and improvements to the present disclosure will readily occur to those skilled in the art. Such alterations, modifications, and improvements are intended to be part of the present disclosure, and are intended to be within the spirit and scope of the invention. Accordingly, the foregoing description and drawing are by way of example only and any invention described in the present disclosure if further described in detail by the claims that follow.

Those skilled in the art will appreciate typical standards of deviation or error attributable to values obtained in assays or other processes as described herein. The publications, websites and other reference materials referenced herein to describe the background of the invention and to provide additional detail regarding its practice are hereby incorporated by reference in their entireties.

1. A method of making a lignocellulosic composition comprising one or more lignocellulosic components, wherein the one or more lignocellulosic components comprise a micron-scale cellulose and/or cellulose nanofibrils (CNF),
the method comprising the steps of:
(a) creating a lignocellulosic slurry by combining the one or more of lignocellulosic components with a liquid component; and
(b) exposing the lignocellulosic slurry to a first drying condition, wherein the first drying condition comprises microwave radiation,
thereby creating a first lignocellulosic composition.

2. The method of claim 1, wherein the first drying condition comprises one or more drying sessions.

3. The method of claim 2, wherein the one or more drying sessions are separated in time by intervals ranging from minutes to days.

4. The method of claim 2 or 3, wherein the one or more drying sessions comprise identical microwave conditions.

5. The method of claim 2 or 3, wherein the one or more drying sessions comprise microwave conditions that vary in one or more microwave parameters from at least one other drying session.

6. The method of claim 5, wherein the one or more microwave parameters comprise microwave power, microwave wavelength, microwave frequency, microwave directionality, microwave flux and duration of microwave exposure.

7. The method of claim 2, wherein the one or more drying sessions comprises one drying session and, during the one drying session, the microwave radiation varies in one or more of power, wavelength, frequency, directionality and flux.

8. The method of claim 7, wherein the variation in microwave radiation results in the first lignocellulosic composition having variable porosity.

9. The method of claim 7, wherein the variation in microwave radiation results in the first lignocellulosic composition having homogenous porosity.

10. The method of claim 1, wherein the microwave radiation has a power of about 5 W/kg of lignocellulosic slurry to about 100 kW/kg of lignocellulosic slurry.

11. The method of claim 1, wherein the lignocellulosic slurry is exposed to the microwave radiation for a duration comprising about 10 seconds to 90 hours per kg of lignocellulosic slurry.

12. The method of any of claims 1-11, wherein the lignocellulosic slurry is contained in a mold when exposed to the microwave radiation for at least one microwave radiation session.

13. The method of any of claims 1-11, wherein the lignocellulosic slurry is not contained in a mold when exposed to the microwave radiation for at least one microwave radiation session.

14. The method of any of claims 1-11, wherein the lignocellulosic slurry is extruded when exposed to the microwave radiation for at least one microwave radiation session.

15. The method of any of claims 1-14, wherein the lignocellulosic slurry comprises about 0.1% to about 20% nanocellulose fiber solids by total weight.

16. The method of any of claims 1-14, wherein the lignocellulosic slurry comprises about 1% to about 10% CNF.

17. The method of any of claims 1-14, wherein the lignocellulosic slurry comprises about 10% to 100% CNF.

18. The method of any of claims 1-17, wherein the lignocellulosic slurry further comprises one or more additives.

19. The method of claim 18, wherein the one or more additives comprise about 1% to about 50% of the lignocellulosic slurry by total weight.

20. The method of claim 18 or 19, wherein the one or more additives comprise wood derivatives, metal particles, latex particles, bioceramics, glass materials, proteins, fluorescent dyes, minerals, natural fibers, polymer materials, or any combination thereof.

21. The method of claim 14 or 19, wherein the one or more additives comprise wood residues.

22. The method of any of claims 1-21, wherein the lignocellulosic slurry is exposed to the microwave radiation until the liquid component content is about 0.01% to about 20% by weight.

23. The method of any one of claims 1-22, further comprising the step of:
(c) exposing the first lignocellulosic composition to a second drying condition, thereby creating a second lignocellulosic composition.

24. The method of claim 23, wherein the second drying condition comprises thermal energy, vacuum, lyophilization or air drying.

25. The method of claim 23 or 24, wherein the second drying condition induces a different rate of liquid component removal than the first drying condition.

26. The method of claims 23-25, wherein the second lignocellulosic composition comprises different material properties compared to the first lignocellulosic composition.

27. The method of claims 23-26, wherein the second lignocellulosic composition comprises a lower liquid component content by weight compared to the first lignocellulosic composition.

28. The method of any one of claims 1-27, further comprising the step of:
(d) covering the first lignocellulosic composition of (b) or covering the second lignocellulosic composition of (c) with a layer of a shell material, thereby creating a dried lignocellulosic composition with an outer layer of shell material.

29. The method of claim 28, further comprising the step of:
(e) exposing the dried lignocellulosic composition with an outer layer of shell material to a third drying condition, thereby creating a dried lignocellulosic composition with an outer layer of dried shell material.

30. The method of claim 29, wherein the outer layer of dried shell material is more dense than the first lignocellulosic composition of (b) and/or the second lignocellulosic composition of (c).

31. The method of claim 29, wherein the outer layer of dried shell material is less dense than the first lignocellulosic composition of (b) and/or the second lignocellulosic composition of (c).

32. The method of any of claims 28-30, wherein the shell material comprises CNF, wood derivatives, metal particles, latex particles, bioceramics, glass materials, proteins, fluorescent dyes, minerals, natural fibers, polymer materials, or any combination thereof.

33. The method of any of claims 29-32, wherein the third drying condition comprises microwave radiation, thermal energy, vacuum, lyophilization or air drying.

34. A composition comprising one or more lignocellulosic components (lignocellulosic composition), wherein the lignocellulosic composition has an internal void space of about 5% to about 95% by volume.

35. The composition of claim 34, wherein the lignocellulosic composition has a density of about 0.03 g/cm³ to about 5 g/cm³.

36. The composition of claim 34, wherein the one or more lignocellulosic components comprise a micron-scale cellulose and/or cellulose nanofibrils (CNF).

37. The composition of any of claims 34-36, wherein the lignocellulosic composition has a nanocellulose fiber solids content of about 1% by weight to about 95% by weight.

38. The composition of any of claims 34-37, wherein the internal void space is distributed homogenously throughout the composition.

39. The composition of any of claims 34-37, wherein the internal void space is distributed variably across at least two regions of the composition.

40. The composition of claim 39, wherein the at least two regions comprise a first region having a first internal void space by volume and a second region having a second internal void space by volume.

41. The composition of claim 40, wherein there is a gradual change in internal void space by volume from the first region to the second region.

42. The composition of claim 40, wherein there is a step-wise change in internal void space by volume from the first region to the second region.

43. The composition of any of claims 40-42, wherein the first region is interior relative to the second region in the lignocellulosic composition.

44. The composition of any of claims 40-42, wherein the second region is interior relative to the first region in the lignocellulosic composition.

45. The composition of any of claims 40-42, wherein the first region is layered horizontally relative to the second region in the lignocellulosic composition.

46. The composition of any of claims 40-45, wherein the first internal void space by volume is less than the second internal void space by volume.

47. The composition of any of claims 34-46, wherein the lignocellulosic composition further comprises one or more additives.

48. The composition of claim 47, wherein the one or more additives modify physical, mechanical or chemical properties of the lignocellulosic composition relative to an identical lignocellulosic composition lacking the one or more additives.

49. The composition of claim 47 or 48, wherein the one or more additives comprise wood derivatives, metal particles, latex particles, bioceramics, glass materials, proteins, fluorescent dyes, minerals, natural fibers, polymer materials, or any combination thereof.

50. The composition of any of claims 34-49, wherein the lignocellulosic composition has a flexural modulus between about 100 kPa and about 2500 MPa.

51. The composition of any of claims 34-50, wherein the lignocellulosic composition has a compression strength between about 10 kPa and about 100 MPa.
